(19) United States
(12) Patent Application Publication
(10) Pub. No.: US 2013/0158934 A1
(43) Pub. Date: Jun. 20, 2013

(54) METHOD FOR AUTOMATICALLY TESTING COMMUNICATION FUNCTIONALITY OF DEVICE UNDER TEST AND COMPUTER-READABLE MEDIA THEREOF

(71) Applicants: CHUN-HUAN LEE, CHANGHUA COUNTY (TW); JYI-YUAN CHEN, NANTOU COUNTY (TW)

(72) Inventors: CHUN-HUAN LEE, CHANGHUA COUNTY (TW); JYI-YUAN CHEN, NANTOU COUNTY (TW)

(73) Assignee: UNIVERSAL SCIENTIFIC INDUSTRIAL (SHANGHAI) CO., LTD., SHANGHAI (CN)

(21) Appl. No.: 13/425,370

(22) Filed: Mar. 20, 2012

(30) Foreign Application Priority Data
Dec. 16, 2011 (TW) 100146784

(51) Int. Cl. G06F 19/00

(52) U.S. Cl. 702/122

(57) ABSTRACT

An exemplary embodiment of present disclosure illustrates a method for automatically testing communication functionality of a device under test (DUT). The method is adapted for driving and controlling at least an instrument to test communication functionality of a DUT through a computing device. The method includes steps described as follows establishing a communication functionality testing system and providing a user interface installed in the computing device, wherein the user interface includes a DUT selection window providing a plurality of DUT module selections; a testing menu window, providing various preset testing item selections; a selected test list displaying configurable sequence for the selected testing items of a specific testing task; a property table provides property and parameter configurations associated with a selected testing item; and a DUT and instrument configuration window for configuring hardware properties of the DUT and instruments as well as the calibration data of the instruments.

### BACKGROUND

1. Technical Field

The present disclosure relates to a method used for automatically testing communication functionality associated with a device under test (DUT) in particular, to a method and a computer-readable media thereof capable for configuring a testing process in accordance to various communication testing requirements and automatically testing the communication functionality associated with the DUT.

2. Description of Related Art

As technology advanced, communication technology continues to be developed and applied in electronic communication device such as smart phone, laptop and tablet. Currently, the communication functionalities have been applied in the electronic communication devices including Bluetooth, Wi-Fi, Global Position System (GPS) and AM/FM radio.

In general, communication functionality circuitry is designed in the embedded System in Package (SiP) module. Further before placing the SiP module on the electronic communication device, manufacturer and R&D personnel must perform various complex communication functionalities tests to the SiP module to ensure the quality and stability of the SiP module. The described tests for instance including sensitivity, error vector, adjacent channel power ratio, transmit power, frequency, voltage, modulation, harmonic distortion and etc. Moreover each test must be conducted under different transmission environment configurations such as different modulations, various data rates, possible transmission channels, different operating voltages, and temperatures and for different communication protocols (e.g., IEEE802.11a/b/g/n). In other words, each and every testing item must accompany with different testing conditions, henceforth, each SiP module would require thousands communication functionality related tests and further the number of testing items and the associated testing conditions increase along with the development of communication technology.

In addition, the described testing items in practice require different types of instruments to perform the corresponding tests and related measurements, consequently, the testing structure must be manually modified to cooperate with different tests. However, every time the test structure changes, additional time must be spend to re-calibrate the instrument to make accurate measurement. Therefore, the testing process of the communication functionality tests for the electronic communication device is not only time consuming but also consumes many man power. Furthermore along with the addition of communication functionality, the number of testing items and overall testing duration increase as well, henceforth the manufacturing cost for the electronic communication device increases consequently the economic and the market competition benefits become gradually diminished.

### SUMMARY

An exemplary embodiment of the present disclosure provides a method used for automatically testing communication functionality associated with device under test (DUT), adapted for driving and controlling at least an instrument to test the communication functionality of a DUT through a computing device. The method includes steps described as follows. A communication functionality testing system is established. A user interface installed in the computing device is provided, wherein the user interface includes a DUT selection window, a testing menu window, a selected test list, a property table, and a DUT and instrument configuration window. The DUT selection window provides a plurality of DUT selections for a user to select the type or the model of the DUT so as to load predefined hardware property and parameters associated with the selected DUT. The testing menu window provides various predefined testing items corresponding to a communication protocol for the user to select the testing items to be performed of the DUT. The selected test list shows the testing items selected by the user from the testing menu window and allows the user to configure the sequence of the selected testing items according to the testing requirement so as to form a specific testing task. The property table provides property and parameter configurations associated with a selected testing item of the selected test list for the user to modify according to a testing requirement. The DUT and instrument configuration window allows the user to input a hardware configuration data associated with the DUT, modify calibration data associated with instruments and configure data communication settings among the computing device, the instruments and the DUT.

According to one exemplary embodiment of the present disclosure, when at least a measurement associated with the testing items falls outside the range of a predefined communication standard, an instant message is transmitted to a communication device of the user through an internet.

According to one exemplary embodiment of the present disclosure, the instant message comprises a form of a text message or an e-mail.

According to one exemplary embodiment of the present disclosure, the DUT is a SiP module having communication capability and placed on a test board having a plurality of connection ports.

An exemplary embodiment of the present disclosure provides a computer-readable media, for storing a computer executable program such as a communication functionality testing program associated with the computing device or associated with the communication device, which is used for executing the described communication functionality testing method.

To sum up, the present disclosure provides a method used for automatically testing communication functionality associated with the DUT, the method used for automatically testing communication functionality associated with the DUT may enable user to customize the testing configurations (such as property and parameter configurations) according to the testing requirements through a software-generated user interface. Further, multiple instruments can be driven and controlled automatically to perform calibration process as well as measurements and analysis for the default testing items of a DUT having communication capability, for example a System in Package module. Consequently, complex communication functionality tests can be quickly and accurately completed, thereby reducing the testing duration saving man power needed for the development and testing process of the DUT having communication functionality.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram of a communication functionality testing system provided in accordance to an exemplary embodiment of the present disclosure.

FIG. 2 is a schematic diagram of a structure of a communication functionality testing system provided in accordance to an exemplary embodiment of the present disclosure.

FIG. 3 is a schematic diagram illustrating a user interface of a communication functionality testing program provided in accordance to an exemplary embodiment of the present disclosure.

FIG. 4 is a flowchart illustrating a method for an automatically testing communication functionality of a DUT provided in accordance to an exemplary embodiment of the present disclosure.

FIG. 5 is a flowchart illustrating a calibration method for the communication functionality testing system provided in accordance to an exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

### An Exemplary Embodiment of a Communication Functionality Testing System

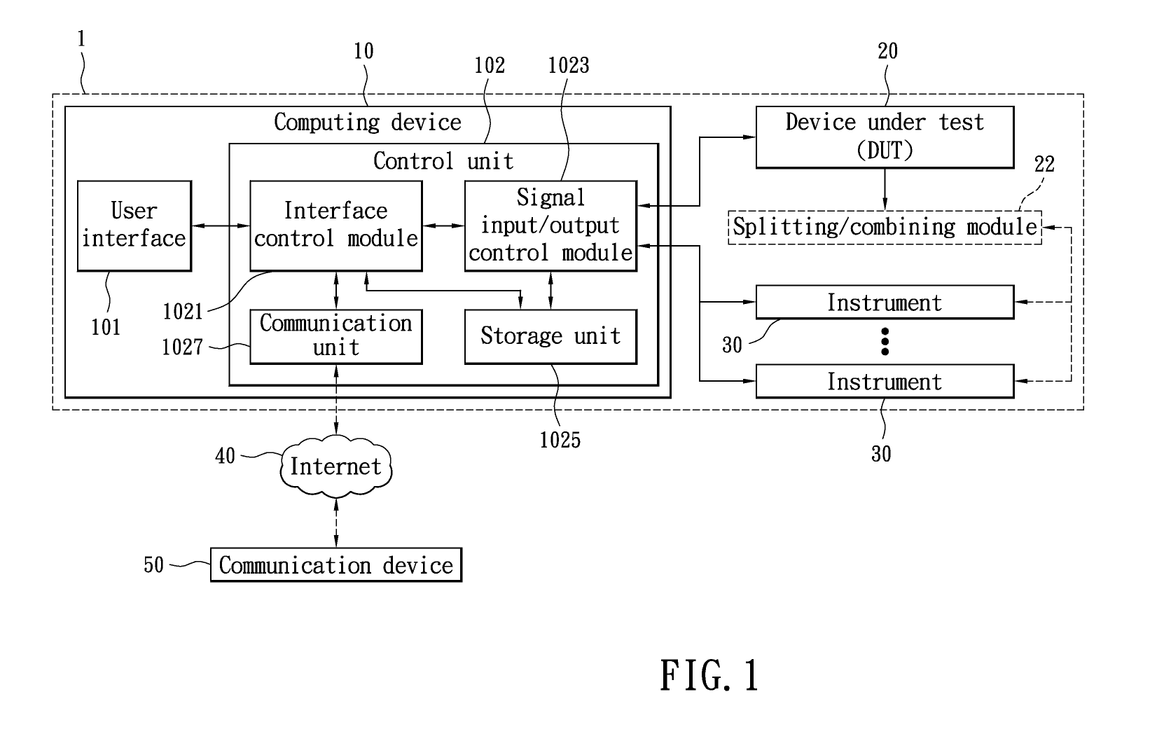

Please refer to FIG. 1, which illustrates a block diagram for a communication functionality testing system provided in accordance to the instant embodiment of the present disclosure. A communication functionality testing system 1 includes a computing device 10, device under test (DUT) 20 and at least an instrument 30. The instrument 30 is coupled to the DUT 20 and the instrument 30 and the DUT 20 are respectively coupled to the computing device 10. The computing device 10 thus can configure the test configurations of the instrument 30 and the DUT 20 while the computing device 10 drives and controls at least an instrument 30 to measure the corresponding communication functionality tests of the DUT 20.

In addition, the DUT 20 may further couple to a splitting/combining module 22 such that a testing signal outputted by the DUT 20 may be transmitted to the instrument 30 for certain communication functionality measurement through the splitting/combining module 22. Specifically, the DUT 20 may split the testing signal and synchronously transmit to multiple instrument 30 through the splitting/combining module 22, so as to have the instruments 30 to perform the analysis and measurement of the testing signal concurrently. Similarly, the testing signal may be generated by the combination of the simulated signals (e.g., simulated noise signal) outputted by the instruments 30 through the splitting/combining module 22, wherein the testing signal which fulfills the testing requirements associated with the communication standard (e.g., IEEE802.11a/b/g/n) and inputted to the DUT 20 for certain communication functionality tests (e.g., Wi-Fi functionality test or packet error rate).

The computing device 10 includes a user interface 101 and a control unit 102. The control unit 102 further includes an interface control module 1021, a signal input/output control module 1023, a storage unit 1025, and a communication unit 1027. The user interface 101 is coupled to the interface control module 1021. The interface control module 1021 is coupled to the signal input/output control module 1023. The interface control module 1021 and the signal input/output control module 1023 are respectively coupled to the storage unit 1025. Moreover, the interface control module 1021 is further coupled to the communication unit 1027.

The user interface 101 is installed in the computing device 10 via software program and is used to provide related configurations of the testing items associated with the DUT 20 and the instruments 30 for a user to conduct related testing configurations and forming a testing task. The interface control module 1021 generates the corresponding control and configuration signals in accordance to the designed testing task so as to drive the DUT 20 and the instruments 30 to perform specific communication functionality tests.

The signal input/output control module 1023 serves as the transmission interface between the computing device 10 and the DUT 20 and the instruments 30. Consequently, the interface control module 1021 can control the operation of the DUT 20 and the instruments 30 through the signal input/output control module 1023. Further, the DUT 20 and the instruments 30 may also transmit testing information to the interface control module 1021 through the signal input/output control module 1023, wherein the testing information could include but not limited to the hardware data associated with the DUT 20 and the instruments 30, the calibration data associated with the instruments 30 and the related measurements. The storage unit 1025 is used to the required data for building the user interface 101, the testing task edited by the user, and the calibration data and measurements of the instruments 30.

Moreover, the interface control module 1021 may transmit an instant message through an internet 40 to a communication device 50 (e.g., handheld electronic device or laptop with network capability) through the communication unit 1027. The instant message may include the testing status and measurements. The interface control module 1021 may transmit the instant message to the communication device 50 when exceptions (e.g., when the measurement falls outside the predefined standard range) occur during the testing process.

The interface control module 1021 may regularly (i.e., every preset time) transmit the instant message to the communication device 50 to allow the user constantly monitoring the testing status. In addition, the user may use an corresponding communication functionality testing application program installed on the communication device 50 to transmit a control signal through the internet 40 to the interface control module 1021 to modify the testing task and to control the operation of the instruments 30 (e.g., stop testing process and modifying the testing task or testing conditions).

It is worth to note, the computing device 10 may be implemented using a computer, for example a desktop or laptop. The described user interface 101 may be software-implemented by programming and installed on the computer. The DUT 20 may for example be a SiP module having communication functionality and placed on a test board having multiple connection ports. The multiple connection ports may respectively through connection accessories coupled to the plurality of instruments 30, wherein each of the instruments 30 may be a spectrum analyzer, a Bluetooth tester, a power meter, a power supplier, a signal generator or a Wi-Fi tester.

The test board may be coupled to the signal input/output control module 1023 through transmission interface, such as Universal Serial Bus (USB) or Recommended Standard 232 (RS-232), and thus the computing device 10 can thereby configure the hardware configuration of the DUT 20. The computing device 10 may transmit signals to control and drive the instruments 30 and receives the measurements through either wired internet transmission interface (e.g., General Purpose Interface Bus (GPIB) or wireless internet transmission interface (Ethernet). That is, the computing device 10 can configures the data transmission configurations among the computing device 10, the DUT 20, and the instruments 30.

It shall be noted that the actual structure and connection method of the computing device 10, the DUT 20, and the instruments 30 may be depend on the actual structure of the testing system and the design requirements. Therefore, the present disclosure does not limit the type, actual structure, and/or implementation method associated with the computing device 10, the DUT 20, and the instruments 30. Moreover, the described communication device 50 may be a computing device or any handheld device having communication capability.

### Another Exemplary Embodiment of a Communication Functionality Testing System

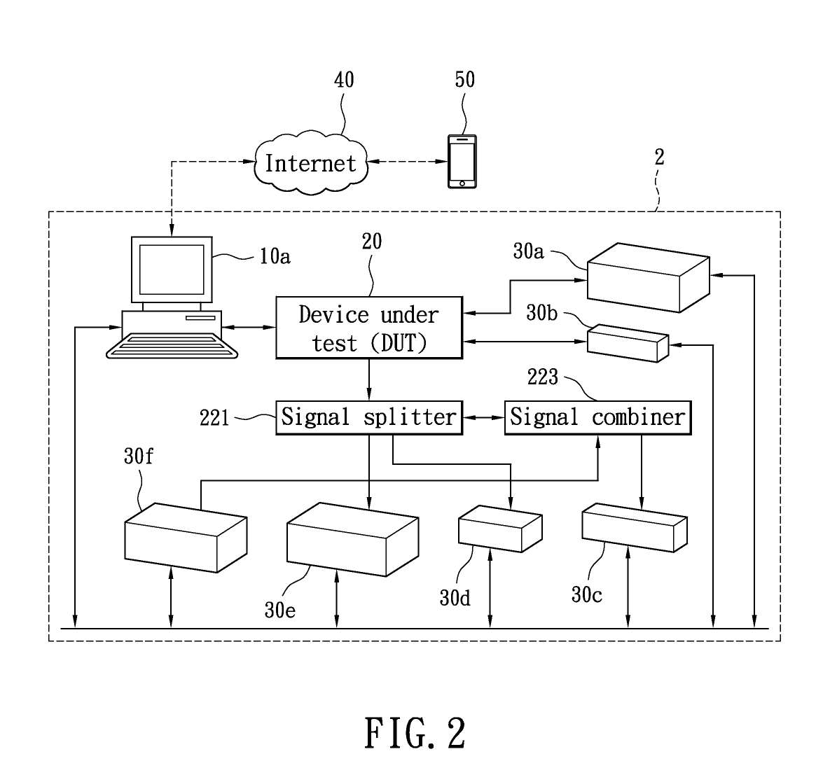

Please refer to FIG. 2, which is a schematic diagram illustrating a structure of a communication functionality testing system. The communication functionality testing system 2 includes a computing device 10a, a DUT 20, and a plurality of the instruments 30a˜30f.

The DUT 20 in the instant embodiments may be a transceiver chip (not shown) and placed on a test board (not shown). The instruments 30 may respectively be a Bluetooth tester 30a, a GPS tester 30b, a Wi-Fi tester 30c, a power meter 30d, a spectrum analyzer 30e and a signal generator 30f. The computing device 10a may be a desktop computer and having a user interface generated by a communication functionality testing program for a user to configure the testing task and related configurations of the testing items. As described, the test board having multiple ports and are respectively connect to the instruments 30a˜30f. The test board is further coupled to the computing device 10a.

Specifically, the test board having a transceiver chip installed is directly coupled to the Bluetooth tester 30a, the GPS tester 30b, and the power meter 30d through signal transmission lines (e.g., coaxial cable). The test board having the transceiver chip installed is further transmitting the testing signal to the spectrum analyzer 30e, the power meter 30d and the Wi-Fi tester 30c through the signal transmission lines and a signal splitter 221. Moreover, the testing signal may be generated by a combination (e.g., signal superposition) of the simulated signals (e.g., simulated noise signal or specific testing signal) outputted by the instruments 30a˜30f, and the testing signal is outputted to the transceiver chip so as to perform related testing process.

The computing device 10a in the instant embodiment may be coupled to the test board through communication interface of USB or RS-232. The described the Bluetooth tester 30a, the GPS tester 30b, the Wi-Fi tester 30c, the power meter 30d, the spectrum analyzer 30e and the signal generator 30f may be coupled to the computing device 10a through the General Purpose Interface Bus (GPIB) or the Ethernet. Henceforth, the computing device 10a may therefore automatically drive the Bluetooth tester 30a, the GPS tester 30b, the Wi-Fi tester 30c, the power meter 30d, the spectrum analyzer 30e and the signal generator 30f in accordance to the user configured testing task formed using the user interface 101 to conduct the communication functionality test and record the measurement accordingly.

The computing device 10a may further transmits an instant message to the communication device 50 (e.g., smart phone, tablet or PDA) to instantly notify the user regarding the testing progress and the testing status (i.e., instantly notify the user regarding the testing duration or measurements associated with a examined testing items) through the internet 40 (e.g., a SMS network or an e-mail server system). In addition, the computing device 10a may also transmit a warning message to the communication device 50 to notify the user when the communication testing system detects an occurrence of exceptions. For instance, when errors found during a measurement of the testing item of the DUT 20). The user may also provide the corresponding control signal (e.g., stop testing task) through a user interface generated by a communication functionality testing application program installed in the communication device 50 to the computing device 10a via internet 40 to remotely control the operations of the instruments 30a˜30f and the DUT 20.

It is worth to note, the testing environment (e.g., temperature and humidity), types, length and lifetime of the transmission lines adopted as well as the connection configuration adopted between the instruments 30a-30f and the DUT 20 can in practice effect the measuring accuracy of the instruments 30a˜30f. In other words, the outputted or received signal might be different from the intended transmitted or received signals. Therefore, calibration data and the corresponding compensation data (e.g., gain and attenuation) associated with the instruments 30a˜30f must be collected before measuring the DUT 20.

The communication functionality testing system in the instant embodiment may further include automated calibration capability. The communication functionality testing system can automatically calibrate the attached instruments, i.e. the Bluetooth tester 30a, the GPS tester 30b, the Wi-Fi tester 30c, the power meter 30d, the spectrum analyzer 30e, and the signal generator 30f using the calibration data obtained prior to the testing process to ensure the measuring accuracy.

Specifically, the user may perform calibration to each and every instrument prior to the establishment of the communication functionality testing system to collect the calibration data (e.g., frequency compensation table) and stored in the computing device 10a. The user may manually connect the Bluetooth tester 30a, the GPS tester 30b, the Wi-Fi tester 30c, the spectrum analyzer 30e, and the signal generator 30f, respectively to the power meter 30d through the corresponding signal transmission lines before connecting to the DUT 20 (e.g., the transceiver chip) so as to measure the strength of the testing signal or the signal distortion in each frequency band.

The obtained calibration data can continue to be used as long as no change is made to the structure of the communication functionality testing system 2 (e.g., no change is made to the connections between the DUT 20 and the instruments 30a˜30f). Alternatively, the calibration data associated with the instruments 30a˜30f in a specific environment configuration may be integrated prior to the establishment of the communication functionality testing system 2 so that there is no need for user to input the calibration data or perform individual instrument calibration for every testing items, therefore reducing the overall testing duration associated with the DUT 20. Moreover, the measurement error caused by frequent modification to the testing structure can be eliminated and the measuring efficiency may be increased.

For instance, the Wi-Fi tester 30c may utilize an associated signal transmission line adopted in the communication functionality testing system (i.e. from the DUT 20, through the signal splitter 221 and the signal combiner 223 to the Wi-Fi Tester 30c) to connect to the power meter 30d. Next through the installed communication functionality testing application program on the computing device 10a, the Wi-Fi tester 30c may be driven to transmit the known testing signal to the power meter 30d to conduct measurements and computation operations to obtain the signal distortion data in each frequency band. For instruments such as the Bluetooth 30a that does not have testing signal generation capability, the signal generator 30f must be used to generate the required testing signal to proceed with the calibration measurement. Based on the above elaboration, those skilled in the art should be able to infer the calibration structure associated with other instruments, further descriptions are therefore omitted.

In addition, once the connections in the testing structure is completed, the computing device 10a can conduct overall connection test to check whether or not the connection between the DUT 20 and the instruments 30a˜30f is properly established through the installed communication functionality testing program. For instance, the computing device 10a may first drive the DUT 20 to transmit a predefined testing signal to an instrument. Then the connection status is determined according to the measurement generated by the instrument. Consequently, measuring errors caused by connection issues may be eliminated while the measuring efficiency can be increased.

It shall be noted that FIG. 2 only serve to illustrate a possible structure implementation of the communication functionality testing system hence the present disclosure is not limited thereto. The quantity and type associated with the instrument as well as the connection configurations adopted between the DUT 20 and the instruments may vary according to the actual testing requirements. In addition, the connection interface between the computing device 10a and the DUT 20 and the instruments 30a˜30f corresponds to the actual types, structure and connection interface of the computing device 10a, the DUT 20 and instruments 30a˜30f. The present disclosure therefore does not limit the actual connection structure between the DUT 20 and the instruments 30a˜30f as well as among the computing device 10a, the DUT 20, and the instruments 30a˜30f.

### An Exemplary Embodiment of a User Interface of a Communication Functionality Testing Program

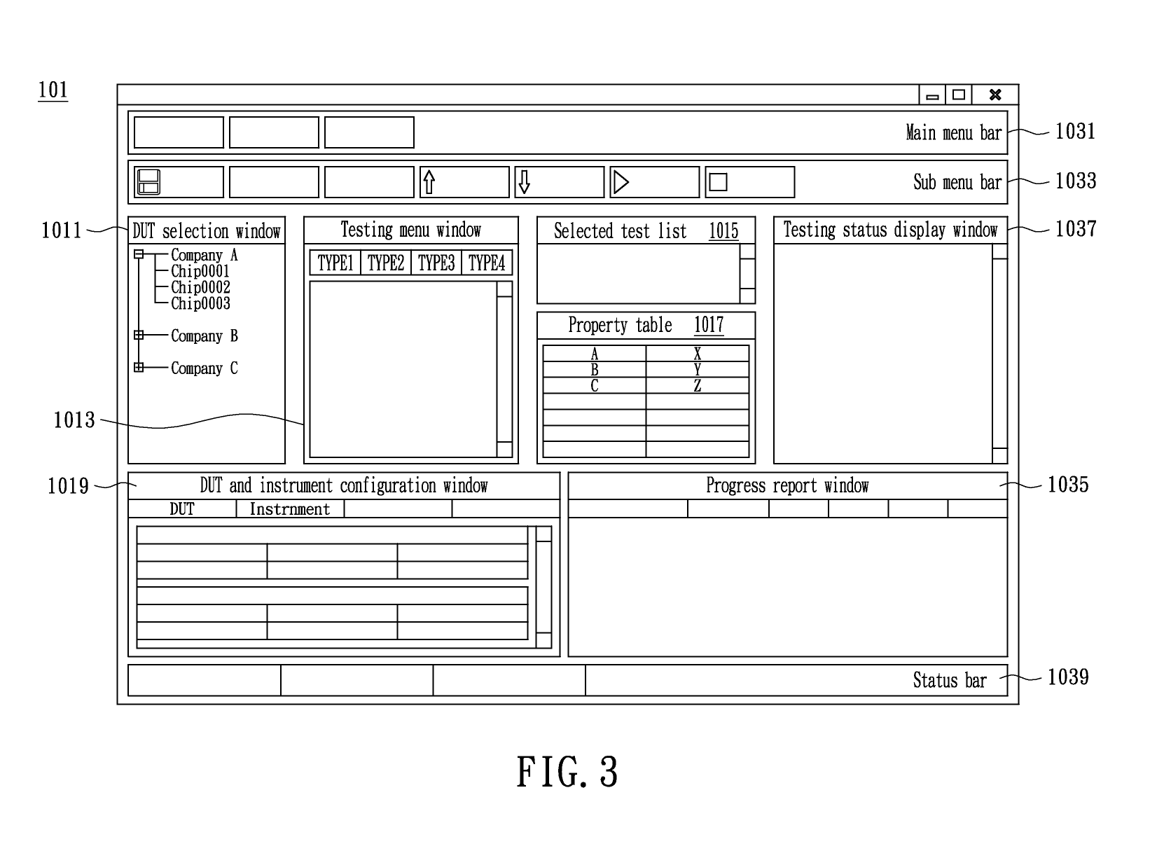

Next, please refer FIG. 3 in conjunction with FIG. 2, wherein FIG. 3 illustrate a user interface of a communication functionality testing program provided in accordance to an exemplary embodiment of the present disclosure. As shown in FIG. 3, a user interface 101 may be displayed on the computing device 10a for user to build a testing task and to configure the hardware configurations of the DUT 20 and the peripheral instruments 30a˜30f.

The user interface 101 includes a DUT selection window 1011, a testing menu window 1013, a selected test list 1015, a property table 1017, a DUT and instrument configuration window 1019, main menu bar 1031, sub menu bar 1033, a progress report window 1035, a testing status display window 1037, and a status bar 1039.

The DUT selection window 1011 provides selections of a plurality type of DUT for a user to select the appropriate type or model for the DUT 20 so as to load the predefined hardware property and parameters associated with the DUT 20. Take transceiver chip for the DUT 20 as an example, the DUT selection window 1011 may display various models of the transceiver chip in accordance to the manufacturer in tree viewer style.

The testing menu window 1013 may categorize different communication standards using tabs, wherein the communication standards includes but not limited to the Bluetooth, the Wi-Fi communication, the AM/FM radio communication, and the global position system (GPS). Further, the testing menu window 1013 may show a list of the default testing item in accordance to different communication standards. As shown in FIG. 3, taking the Wi-Fi communication system as an example, the testing menu window 1013 may display error vector magnitude (EVM), spectrum mask, phase noise, current/voltage, packet error rate (PER) and so on, for user to selected the testing items wished to be conducted.

The selected test list 1015 is used to display the user selected testing items. In addition, the user may arrange the sequence of the selected testing item according to the testing requirements.

The property table 1017 is used for displaying the related configurable testing parameters and testing condition (i.e. property and parameter configurations) associated with a selected testing item of the selected test list 1015 for the user to make adjustment according to the testing requirements. For instance, the related configurable testing parameters and testing condition may include but not limited to the operation voltage, activate or disable the function of Distributed Coordination Function (DCF), signal modulation, guard interval, data rate, transmission power as well as packet format and length thereof.

The DUT and instrument configuration window 1019 enables the user to perform hardware related configurations for the DUT 20 and the instruments 30a˜30f. In particularly, the DUT and instrument configuration window 1019 has multiple tabs corresponding to different configurations. The configurations may include but not limited to the firmware configuration, hardware connection and data transmission rate configuration associated with the DUT 20 and the instruments 30a˜30f. For example, the user may upload related configuration data of the DUT 20 and the instruments through the DUT and instrument configuration window 1019. The user may also manually input or configure the calibration data associated each individual instrument 30a˜30f through the DUT and instrument configuration window 1019 and have the computing device 10a transmit the calibration data to the corresponding instrument. The computing device 10a can thus automatically perform calibration process for each instrument 30a˜30f to avoid having measuring errors caused by the instruments and the associated signal transmission lines so as to perform accurate measurements. Furthermore, the user can configure data communication settings among the computing device 10a, the instruments 30a˜30f and the DUT 20 through the DUT and instrument configuration window 1019.

Moreover, the use may perform save, read or edit operations to the developed testing task with the main menu bar 1031. The sub menu bar 1033 enables the user to do advance operations such as saving the testing task, add or delete testing items from the testing task, modifying the sequence among the selected testing items, and active/disable the execution of the testing task.

The progress report window 1035 briefly lists the testing progress and status for each testing items in the testing task. To put it concretely, the progress report window 1035 lists the name of the testing item, start testing time, end testing time, testing progress, testing status, and the measurement of each testing item. The testing status display window 1037 function as a log window and provides detail measurements to the user. The testing status display window 1037 may also display details report regarding any exceptions such as failure of a testing item and the caused thereof or unusual situation and the caused thereof during the testing process. The status bar 1039 may display the execution status of a testing task, the start and total testing duration associated with the testing task.

For example, the user may first select the DUT 20 to be tested by double clicking the appropriate model number through the DUT selection window 1011 on the user interface, so as to load the predefined hardware property and parameters for the DUT 20. Next, the user may configure hardware connection configurations such as the transmission interface and data rate for the DUT 20 and the instruments 30a˜30f through the DUT and instrument configuration window 1019. At the same time, the user may upload the firmware associated with the DUT 20 and the instruments 30a˜30f and the calibration data of the instruments 30a˜30f through the DUT and instrument configuration window 1019. It is worth to note that, the calibration data of the instruments 30a˜30f may be also obtained and stored in the computing device 10a during the automated calibration process conducted by the communication functionality testing system 2. Consequently, the communication functionality testing program may automatically load the calibration data and transmit the calibration data to each corresponding instrument 30a˜30f prior to the execution of the testing task.

The user may also manually editing the preload calibration data associated with the instruments 30a˜30f through the DUT and instrument configuration window 1019. The user can then select the communication standards (e.g., Bluetooth, Wi-Fi communication system, AM/FM radio system, GPS communication) for the communication functionality to be tested by selecting the appropriate tabs through the testing menu window 1013. The testing menu window 1013 immediately display a list of predefined testing items associated with the communication standards for the user to select from. The selected test list 1015 displays the selected testing item concurrently as the user selected from the testing menu window 1013. The user may further arrange the sequence of the testing items in the selected test list 1015 via the sequence adjustment buttons on the sub menu bar 1033.

Moreover, the user may select any testing items from the selected test list 1015 to conduct further configurations such as testing parameters and testing conditions in the property table 1017. The user may also save the developed testing task as well as to start or stop the execution of the testing task through either the main menu bar 1031 or the sub menu bar 1033.

The above described user interface 101 may be designed and implement using object-oriented programming language. The user may utilize object defining method, quickly add or modify the functionality of the automated testing items as well as the form of the related control objects to achieve the objective of automated testing. Or equivalently, the user may add or modify the user interface 101 according to the actual design needs. Therefore, it shall be noted that FIG. 3 only serve as a diagram for illustrating a user interface described in the instant embodiment of the present disclosure and the present disclosure is not limited herein.

### An Exemplary Embodiment of a Method for Testing the Communication Functionality

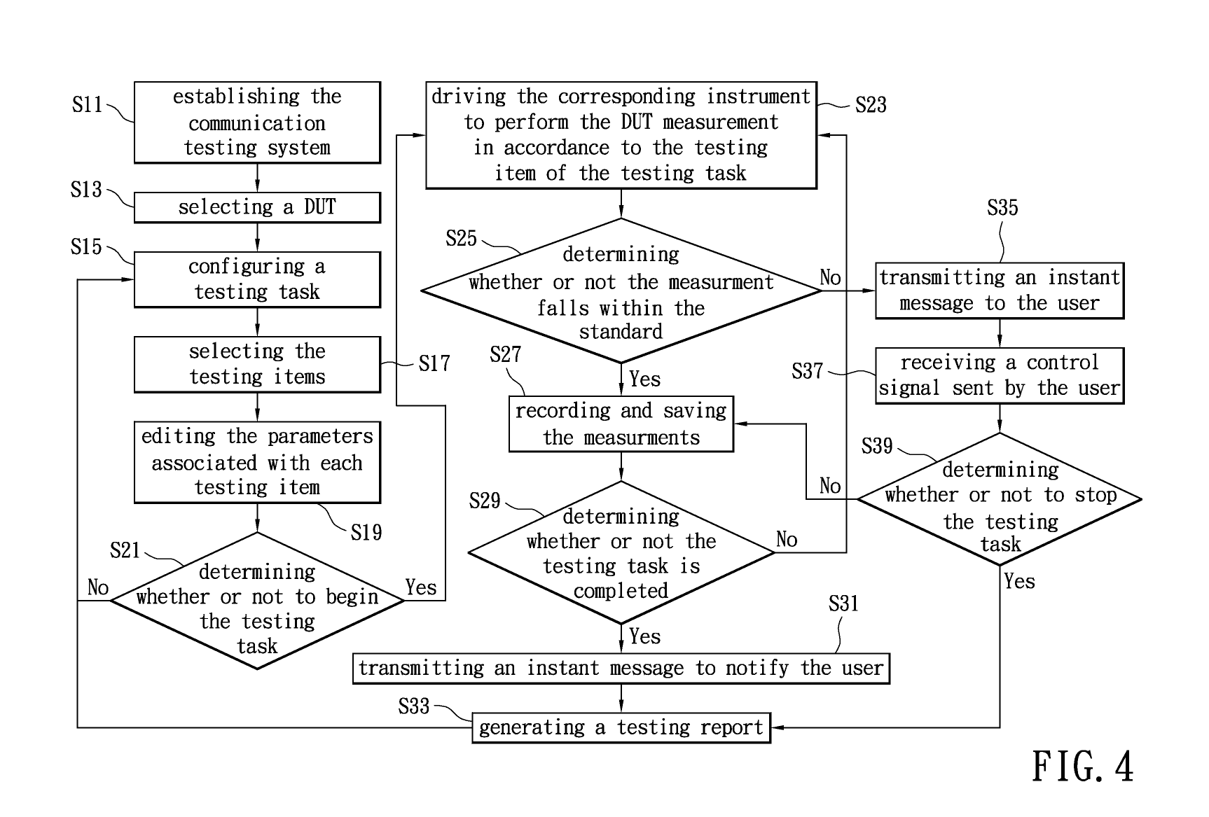

Please refer to FIG. 4, in conjunction with FIG. 2 and FIG. 3. FIG. 4 shows a flow diagram illustrating a method used for automatically testing communication functionality associated with the DUT provided in an exemplary embodiment of the present disclosure. In Step S11, establishes a communication testing system as shown in FIG. 2. Particularly, a DUT 20 (e.g., a test board having a transceiver chip thereof) electrically connected to the corresponding instruments 30a˜30f via the signal transmission lines (e.g., cable). At same time, connect the DUT 20 and the instruments 30a˜30f through the corresponding transmission interface (i.e., GPIB and USB) to the computing device 10a to have the computing device 10a driving and controlling the DUT 20 and the instruments 30a˜30f through the data transmission interface.

Then, the computing device 10a provides a user interface 101, enabling the user to select the model of the DUT according to the manufacturer (Step S13) and to edit a testing task (Step S15). The edition of a testing task including selecting testing items, arranging the sequence of the testing items, and configuring testing parameters and properties associated with testing items (Step S17 and Step S19). Subsequently, in Step 21 the computing device 10a determines whether or not to begin the execution of the tasking task. When the computing device 10a determines that the user has not activated the execution of the testing task on the user interface 101, go to the Step S15.

Conversely, when the computing device 10a determines that the user has activated the execution of testing task, driving and controlling the corresponding instruments 30a˜30f to measure and analyze the DUT 20 in accordance to the testing items of the testing task (Step S23). For instance, the computing device 10a may drive and control the instruments 30a, 30b, 30c, 30e and 30f to generate and transmit the simulated signals through the signal combiner 223 inputted to the DUT 20 to perform the certain communication functionality test. Similarly, the computing device 10a may also drive and control the DUT 20 to transmit the testing signal to the corresponding instrument, so as to perform related measurement and analysis. The computing device 10a may further receive the measurement from the DUT 20, the instrument 30a, 30b, 30c, 30d, or 30f, and determine whether or not the measurement associated with a testing item fulfill the communication standard (e.g. falling with a preset standard range of the communication standard) in Step S25.

When the computing device 10a determines that the measurement falls within the preset standard range of the communication standard associated with the testing item, executes Step S27, otherwise, executes Step S35.

In Step S27, the computing device 10a records and stores the measurement. Further in Step S29, the computing device 10a determines whether or not the testing task is completed i.e. all the testing items have been conducted. If the computing device 10a determines that the testing task has not been completed, then executes Step S23. Conversely, when the testing task is determined to be completed, then the computing device 10a can transmit an instant message to the communication device 50 to notify the user through the internet 40 (Step S31). The instant message may include the name of the testing items and the associated measurement. Moreover, the instant message may be sent to the communication device 50 using the form of SMS or email. Further, in Step S33, the computing device 10a generates a testing report based on the measurements and displays on the monitor of the computing device 10a.

In Step S35, the computing device 10a transmits the instant message to the communication device 50 to notify the user that the measurement falls outside the standard range according to the communication standard (e.g., irregular condition). Subsequently, the computing device 10a may receive a control signal from the communication device 50 (Step S37) and determines whether or not to continue the testing task according to the control signal (Step S39). In other words, the communication device 50 has the corresponding communication functionality testing application program, so that the user can perform corresponding control in according to the instant message through a user interface generated by the communication functionality testing application program in the communication device 50. For instance, the control signal is transmitted through the internet 40 to the computing device 10a to decide whether to continue or to stop the execution of the testing ask or to perform other controlling operation including modify the testing condition, testing items, or the sequence of the testing items. Next, when determined to continue with the execution of the current testing task, executes Step S27, otherwise executes Step S33.

It is worth to note, the user can have the instant message sent to the communication device 50 to notify the use at the completion of each testing functionality of the testing task through the user interface 101. Similarly, the user can also have the testing statistics (e.g., the name of the testing items, testing duration, testing progress and measurement) regularly sent to the communication device 50 through the user interface 101 every predefined time (e.g., every preset interval) for the user to constantly monitor the testing status. Furthermore, the use may also reconfigure the sequence of the testing items, testing property of the testing items or change the testing item using the user interface provided by the communication functionality testing application program of the communication device 50 to remotely manage the testing process flow of the testing task according to the testing status.

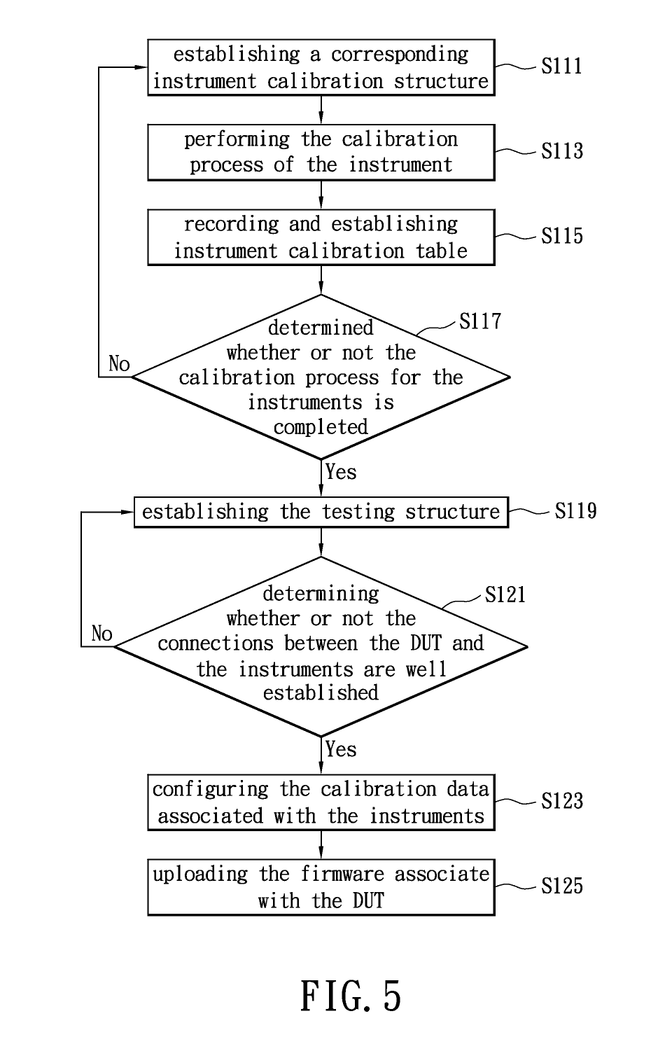

Next, please refer to FIG. 5 in conjunction with FIG. 2 and FIG. 3, wherein FIG. 5 provides a flowchart illustrating a calibration method for the communication functionality testing system provided in accordance to an exemplary embodiment of the present disclosure. The calibration method can be executed during the execution of the Step S11. In Step S111, a corresponding instrument calibration structure is established. Or equivalent, a corresponding calibration structure for each instruments 30a˜30f is established. For example, the Bluetooth tester 30a, the GPS tester 30b, the Wi-Fi Tester 30c, the spectrum analyzer 30e, and the signal generator 30f can respectively through a GPIB or Ethernet connected to the computing device 10a, and corresponding signal transmission lines connected to the power meter 30d.

In Step S113, the computing device 10a drives the instrument 30a˜30f to perform calibration measurement. Taking Wi-Fi tester 30c as an example, the computing device 10a can drive the Wi-Fi tester 30c to transmit a known signal to the power meter 30d through the associated signal transmission line while drive the power meter 30d to proceed with the related measurement and return the calibration result back to the computing device 10a for further analysis. The computing device 10a can for example through compute and record the difference between the power meter 30d measured signal and the known signal in each frequency band to obtain gain or attenuation in the signal to serve as the calibration reference data (e.g., calibration data table) (Steps S115). Those who skilled in the art should be able to infer the computation of the calibration data and implementation method thereof for the instrument, further description are therefore omitted.

In addition, in Step S115, the computing device 10a automatically stores and tabulates the calibration data after obtaining the calibration data associated with any instruments 30a˜30f. Consequently, when establishes the testing structure, the communication functionality testing program of the communication functionality testing system 2 can automatically load the corresponding calibration data without having the user manually inputted the calibration data.

The computing device 10a determines whether or not all the instruments in the system have been calibrated (Step S117). If the computing device 10a determines that all the instruments have been calibrated, executes Step S119, otherwise executes S111.

In Step S119, when completes the calibration process, developing the instrument calibration data table as well as building the corresponding testing structure. Subsequently, the computing device 10a determines whether the connection between the DUT 20 and the instruments are well established. For instance, the computing device 10a can drive the DUT 20 to transmit a known signal to an instrument, the computing device 10 can through the signal received by the instrument determining the connections between the DUT 20 and any of the instruments 30a˜30f.

When determines that the connections between the DUT 20 and the instruments 30a˜30f are well established, executes Step S123. Conversely, when determines errors in the connection between the DUT 20 and the instruments 30a˜30f, executes Step S119 to check for the connections in the testing structure.

Next, the computing device 10a provides the user interface 101 for the user to manually configure the calibration data associated with the instruments 30a˜30f as well as inputting the firmware data associated with the DUT 20 (Step S125). The actual inputting method have been described in the aforementioned embodiment, further description are therefore omitted.

It shall be noted that the calibration method and calibration data generation method associated with the instruments 30a˜30f may vary according to the actual testing structure and needs. FIG. 5 only serves to illustrate a calibration method in accordance to the exemplary embodiment of the present disclosure, thus the present disclosure is not limited thereto.

Moreover, the present disclosure also discloses a computer-readable media for storing the computer executable program of the aforementioned communication functionality testing program associated with the computing device 10a and the communication functionality testing application program associated with the communication device 50 so as to generate the described user interface and to execute the illustrated method. The computer-readable media may be a floppy disk, a hard disk, a compact disk (CD), a flash drive, a magnetic tape, accessible online storage database or any type of storage media having similar functionality known to those skilled in the art.

In summary, the present disclosure provides a method used for automatically testing communication functionality associated with device under test (DUT), the method used for automatically testing communication functionality associated with DUT may through a software-generated user interface, enabling user to customize the configurations according to the testing requirements. Further, multiple instruments can be driven to automatically perform calibration process as well as preset testing items measurements and analysis of a DUT having communication capability, for example a System in Package module. Consequently, complex communication functionality tests can be quickly and accurately completed, thereby reducing the testing duration and man power needed in the development and testing process of a DUT having communication functionality.

Moreover, the disclosed method used for automatically testing communication functionality may automatically transmit instant message to the user at completion of the testing process or occurrence of exception during the testing progress. The user may through a communication device transmit a control signal to monitor and regulate the operation of the instruments and the DUT. Thus the disclosed method used for automatically testing communication functionality can effectively and quickly perform complete communication test to the DUT thereby reduce the testing duration, man power required, and the testing cost associated with the DUT.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A method used for automatically testing communication functionality associated with a device under test (DUT), adapted for driving and controlling at least an instrument to test the communication functionality of the DUT through a computing device, comprising:
establishing a communication functionality testing system; and
providing a user interface installed in the computing device, wherein the user interface comprises:
a DUT selection window, providing a plurality of DUT selections for a user to select the type or the model of the DUT so as to load predefined hardware property and parameters associated with the DUT;
a testing menu window, providing various predefined testing items corresponding to a communication protocol for the user to select the testing items to be performed of the DUT;
a selected test list, showing the testing items selected by the user from the testing menu window and allowing the user to configure the sequence of the selected testing items according to testing requirements so as to form a specific testing task;
a property table, providing property and parameter configurations associated with the selected testing item of the selected test list for the user to modify according to the testing requirements; and
a DUT and instrument configuration window, for the user to input a hardware configuration data associated with the DUT, modify calibration data associated with instruments and configure data communication settings among the computing device, the instruments and the DUT.

2. The method used for automatically testing communication functionality associated with the DUT according to claim 1, wherein the user interface further comprises:
at least a menu bar, means for the user to store or load the configurations associated with the testing items of the testing task, the measurements associated with the DUT, to configure the testing task, and to control the testing items to start or stop;
a progress report window, showing a testing status information associated with at least one of the testing items in the testing task, wherein the testing status information comprises at least one of a name, a start testing time, a testing duration, a testing progress, and the measurement of the testing item;
a testing status display window, providing a detail status report regarding the testing progress associated with the testing item; and
a status bar, showing an execution status, a starting time, an overall testing duration, and a testing status of the testing task.

3. The method used for automatically testing communication functionality associated with the DUT according to claim 2, wherein the steps for establishing the communication functionality testing system comprise of having the computing device coupled to both the DUT and the instruments through a signal input/output control module and the DUT coupled to the instruments, the computing device through the signal input/output control module driving and controlling the corresponding instruments to test the DUT according to the testing task and receiving the corresponding measurements outputted by the instruments.

4. The method used for automatically testing communication functionality associated with the DUT according to claim 2, further comprising:
determining whether or not the connection between the DUT and the instruments is properly established at the completion of constructing the communication functionality testing system.

5. The method used for automatically testing communication functionality associated with the DUT according to claim 2, comprising:
determining whether or not to start to execute the testing task when finishing configuring the testing task; and
driving the corresponding instruments to perform the DUT measurements according to the sequence of the testing items in the testing task to generate the corresponding measurements when determining to execute the testing task.

6. The method used for automatically testing communication functionality associated with the DUT according to claim 5, further comprising:
when at least a measurement associated with the testing item falls outside the range of a predefined communication standard, the testing status display window displays the corresponding information to the user and an instant message is transmitted to a communication device of the user through an internet;
wherein the instant message comprises at least one of the testing status and the associated measurement.

7. The method used for automatically testing communication functionality associated with the DUT according to claim 6, further comprising:
when receiving the instant message, the user through a communication functionality testing application program installed in the communication device, transmits a control signal through the internet to control the communication functionality testing system, wherein the control signal is a testing task stop command or a testing task modifying command or a testing condition modification command.

8. The method used for automatically testing communication functionality associated with the DUT according to claim 5, further comprising
regularly transmitting an instant message to a communication device of the user through an internet during the execution of the testing task;
wherein the instant message comprises at least one of the testing progress, the testing status and the associated measurement of the associated testing item.

9. The method used for automatically testing communication functionality associated with the DUT according to claim 5, further comprising:
transmitting an instant message to the communication device through a communication system at completion or termination of the testing task or the testing item;
wherein the instant message comprises at least one of the testing status and the associated measurement.

10. The method used for automatically testing communication functionality associated with the DUT according to claim 1, further comprising of steps for generating the calibration data associated with the instrument, wherein the steps for generating the calibration data associated with the instrument comprising:
establishing a calibration structure associated with the instrument;
performing a calibration process associated with the instrument; and
generating and recording the instrument calibration data associated with the instrument automatically;
wherein the calibration process comprises measuring the signal gain or the signal attenuation of a predefined testing signal in each testing frequency band.

11. The method used for automatically testing communication functionality associated with the DUT according to claim 10, further comprising:
inputting or editing the instrument calibration data in the DUT and instrument configuration window of the user interface to serve as the measurement compensations for the instrument.

12. The method used for automatically testing communication functionality associated with the DUT according to claim 6, wherein the instant message comprises a form of a text message or an e-mail.

13. The method used for automatically testing communication functionality associated with the DUT according to claim 7, wherein the instant message comprises a form of a text message or an e-mail.

14. The method used for automatically testing communication functionality associated with the DUT according to claim 8, wherein the instant message comprises a form of a text message or an e-mail.

15. The method used for automatically testing communication functionality associated with the DUT according to claim 9, wherein the instant message comprises a form of a text message or an e-mail.

16. The method used for automatically testing communication functionality associated with the DUT according to claim 1, wherein the communication protocol being used corresponds to the communication standard of the Bluetooth, the Wi-Fi communication, the global position system, or the AM/FM radio communication.

17. The method used for automatically testing communication functionality associated with the DUT according to claim 1, wherein the DUT is a System in Package (SiP) module having communication capability and placed on a test board having a plurality of connection ports.

18. A computer-readable media, for storing a computer executable program, wherein the computer executable program comprises program codes for executing the method described in claim 1.
